(19) United States
(12) Patent Application Publication
(10) Pub. No.: US 2009/0266893 A1
(43) Pub. Date: Oct. 29, 2009

(54) MOBILE DEVICE AND TRADE METHOD USING THE MOBILE DEVICE

(75) Inventor: CHUN-AN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/274,340

(22) Filed: Nov. 19, 2008

(30) Foreign Application Priority Data
Apr. 25, 2008 (CN) 200810301303.1

(51) Int. Cl. G06K 7/06

(52) U.S. Cl. 235/441

(57) ABSTRACT

A mobile device for interacting with a trade device includes: a card reader configured for reading data of an integrated circuit (IC) card, when a processor detects that the card reader contacts or receives the IC card; and a near field communication device configured for connecting to the trade device when the mobile device needs to transact with the trade device, and outputting data of a selected IC card for implementing a transaction between the mobile device and the trade device.

### BACKGROUND

1. Field of the Invention

Embodiments of the present disclosure relate to mobile devices, and particularly to mobile devices transacting with trade devices.

2. Description of Related Art

Generally, consumers have to carry or manage multiple debit/credit cards or multiple financial accounts for various reasons. Carrying or managing less cards is always more convenient and safer. In order to avoid carrying much money and making the shopping expediently, users have to carry many cards in a wallet, such as credit cards, ATM cards, identification cards and so on.

However, it is not convenient nor safe for the users to carry many cards when shopping or dealing other trades. If the wallet is lost, all the cards are lost. Generally, the cards are issued by different banks or organizations, thus the users have to go all the banks or organizations to withdraw the lost cards and obtain the new cards. Therefore it is very troublesome if the cards are lost.

What is needed, therefore, is a mobile device and a trade method using the mobile device to overcome the above-stated problems.

### BRIEF DESCRIPTION OF THE DRAWINGS

FIG. 1 and FIG. 2 are block diagrams of one embodiment of a mobile device including a card reader and a near field communication (NFC) device.

FIG. 3 is a flowchart of one embodiment of a method for reading data of an integrated circuit (IC) card by using the mobile device.

FIG. 3 is a flowchart of one embodiment of a method for transacting by using the mobile device.

### DETAILED DESCRIPTION OF CERTAIN INVENTIVE EMBODIMENTS

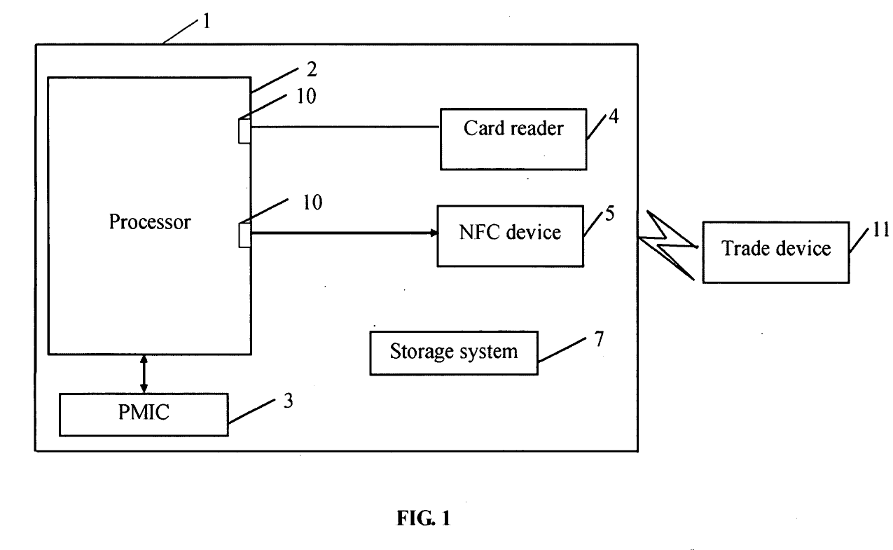

FIG. 1 is a block diagram of one embodiment of a mobile device 1 for transacting with a trade device 11. The trade device 11 may be point of sales device in one exemplary example. The mobile device 1 may be a mobile phone in one exemplary embodiment. In one embodiment, the mobile device 1 includes a processor 2, a power manage integrated circuit (PMIC) 3, a card reader 4, and a near field communication (NFC) device 5. The card reader 4 and the NFC device 5 connects with the processor 2 respectively via an interface 10, such as a universal asynchronous receiver/transmitter interface (UART), a serial peripheral interface (SPI), a Universal Serial Bus (USB) or an inter integrated circuit (I²C) interface. The processor 2 may be an Advanced Risc Machine (ARM) processor in one embodiment, but the present disclosure is not limited thereto.

The card reader 4 is configured for reading transactional data of one or more integrated circuit (IC) cards when the processor 2 detects that the card reader 4 contacts or receives the one or more IC cards. The IC cards may be, but is not limited to, credit cards, automatic teller machine (ATM) cards, identification (ID) cards, or subscriber identity module (SIM) cards. For example, the card reader 4 reads data of an ATM card when the card reader 4 contacts or receives the ATM card. The read transactional data of the ATM card may include a user name, identification numbers, credit limit, a bank name, transaction records, and so on.

The NFC device 5 is configured for connecting with the trade device 11 via a wireless network when the mobile device 1 needs to perform a data transaction between the mobile device and the trade device 11, and outputting data of a selected IC card to the trade device 11 for implementing a data transaction.

The mobile device 1 further includes a power manage integrated circuit (PMIC) 3, which is connected with the processor 2 for supplying power to assure normal operations of the processor 2 and the mobile device 1.

The mobile device 1 further includes a storage system 7 for storing the read transactional data of the IC cards and other files of the mobile device 1.

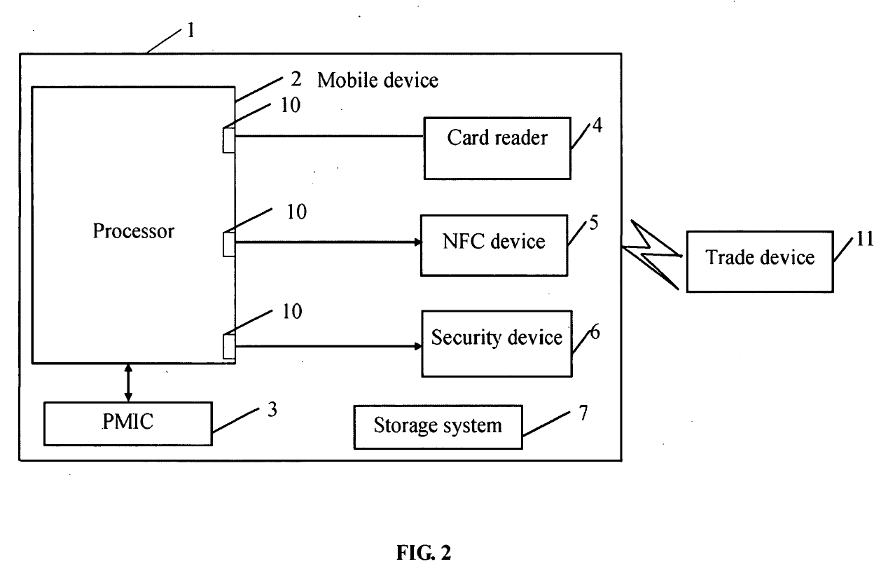

In order to secure data of the IC cards, the mobile device 1 may further include a security device 7 (shown in FIG. 2). The security device 7 may prompt a user to input a password or some other authentication procedure to verify an authenticity of the user. The authentication procedure may be a fingerprint, or an image recognize before the mobile device 1 allows/permits/finalizes the transaction with the trade device 11. Accordingly, depending on the embodiment, the security device 6 may be a fingerprint scanner or an image recognizer device. If the inputted passwords, the fingerprint, or the image recognize is wrong, the security device 7 rejects the transaction between the mobile device 1 and the trade device 11.

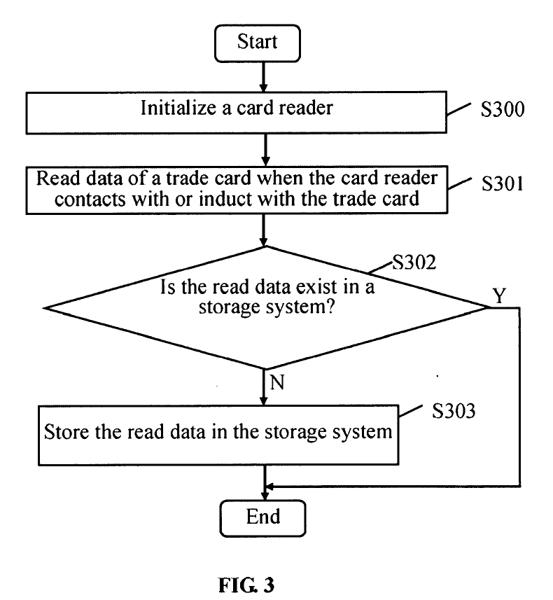

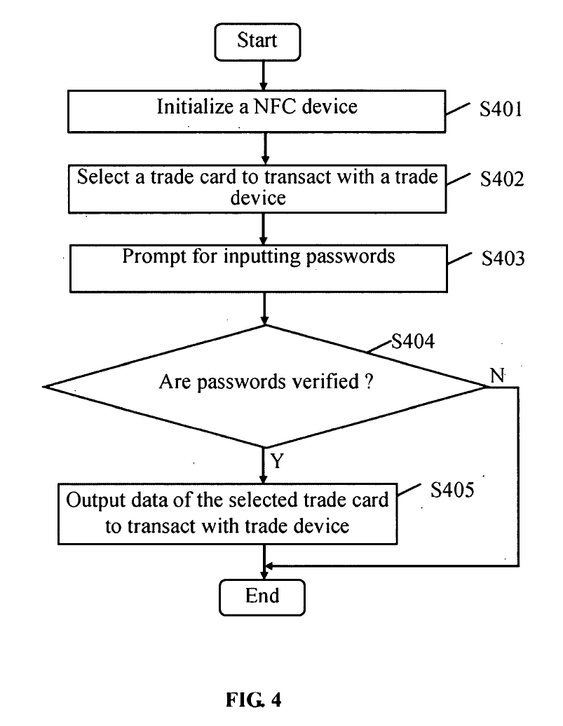

FIG. 3 is a flowchart of one embodiment of a method for reading data of an IC card by using the mobile device 1 in FIG. 1 or FIG. 2. Depending on the embodiment, additional blocks may be added, others deleted, and the ordering of the blocks may be changed. In block S300, the processor 2 initializes the card reader 4 when the mobile device 1 is powered on.

In block S301, the card reader 4 reads transactional data of an IC card when the processor 2 detects that the card reader 4 contacts or receives the IC card. The IC card may be, but not limited to, the credit card, the ATM card, the ID card, or the SIM card. The read transactional data of the ATM card may include a user name, identification numbers, an amount of money, a bank name, transaction records, and so on. The read transactional data of the IC card is stored in the storage system 7.

In block S302, the processor 2 determines if the read transactional data exists in the storage system 7. If the read transactional data exists in the storage system 7, the procedure goes end. In one embodiment, if the read transactional data exists in the storage system 7, the processor 2 may overlap the existing data by using the read data of the IC card.

Otherwise, if the read data does not exist in the storage system 7, the procedure goes to block S303 to store the read transactional data of the IC card in the storage system 7.

FIG. 4 is a flowchart of one embodiment of a method for transacting by using the mobile device 1 in FIG. 1 or FIG. 2. Depending on the embodiment, additional blocks may be added, others deleted, and the ordering of the blocks may be changed. In block S401, the processor 2 initializes the NFC device 5 when the mobile device 1 needs to transact with the trade device 11. The mobile device 1 connects with the trade device 11 via a wireless network by using the NFC device 5. As mentioned above, the trade device 11 may be point of sales device in one exemplary embodiment.

In block S402, an IC card for implementing a transactional data transaction between the mobile device and the trade device 11 may be selected. The IC card may be, but not limited to, a credit card, an ATM card, an ID card, or a SIM card.

In block S403, the security device 6 prompts the user to input a password or some other authentication procedure to verify an authenticity of the user.

In block S404, the security device 6 determines if the inputted password is verified. If the password is verified, the procedure goes to block S405. Otherwise, if the password is not verified, the processor 2 rejects the current transaction, and the procedure goes to end.

In block S405, the NFC device 5 outputs the transactional data of the selected IC card for implementing a data transaction between the mobile device and the trade device 11.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile device for interacting with a trade device, the mobile device comprising:
a card reader configured for reading transactional data of an integrated circuit (IC) card when a processor of the mobile device detects that the card reader contacts or receives the IC card; and
a near field communication device configured for connecting to the trade device, and for outputting transactional data of a selected IC card for implementing a data transaction between the mobile device and the trade device.

2. The mobile device as claimed in claim 1, further comprising a security device for securing the transactional data of the IC card.

3. The mobile device as claimed in claim 2, wherein the security device is configured for prompting a user of the mobile device that a fingerprint of the user, an image of the user to be recognized, or password of the user need to be inputted into the mobile device.

4. The mobile device as claimed in claim 1, wherein the processor is an Advanced Risc Machine processor.

5. The mobile device as claimed in claim 1, wherein the cards are credit cards, automatic teller machine (ATM) cards, identification (ID) cards, or subscriber identity module (SIM) cards.

6. A method for interacting with a trade device using a mobile device, the mobile device comprising a processor, a card reader and a near field communication device, the card reader and the near field communication device connecting with the processor, the method comprising:
reading transactional data of an integrated circuit (IC) card when the processor detects that the card reader contacts or receives the IC card;
connecting the mobile device to a trade device using a near field communication device when the mobile device needs to transact with the trade device; and
selecting an IC card in a storage system in the mobile device; and
outputting transactional data of the selected IC card for implementing a data transaction between the mobile device and the trade device.

7. The method as claimed in claim 6, further comprising:
prompting a user of the mobile device that a fingerprint of the user, an image of the user to be recognized, or password of the user need to be inputted into the mobile device.

8. The method as claimed in claim 6, wherein the processor is an Advanced Risc Machine processor.

9. The method as claimed in claim 6, wherein the IC card is one of credit cards, automatic teller machine (ATM) cards, identification (ID) cards, or subscriber identity module (SIM) cards.

10. A storage medium having stored thereon instructions that, when executed by a mobile device, cause the mobile device to perform a trade method, the mobile device comprising a processor, a card reader and a near field communication device, the method comprising:
reading transactional data of an integrated circuit (IC) card when the processor detects that the card reader contacts or receives the IC card;
connecting the mobile device to a trade device using a near field communication device when the mobile device needs to transact with the trade device; and
selecting an IC card in a storage system in the mobile device; and
outputting transactional data of the selected IC card for implementing a data transaction between the mobile device and the trade device.

11. The storage medium as claimed in claim 10, further comprising:
prompting a user of the mobile device that a fingerprint of the user, an image of the user to be recognized, or password of the user need to be inputted into the mobile device.

12. The storage medium as claimed in claim 10, wherein the processor is an Advanced Risc Machine processor.

13. The storage medium as claimed in claim 10, wherein the IC card is one of credit cards, automatic teller machine (ATM) cards, identification (ID) cards or subscriber identity module (SIM) cards.
